(19) United States
(12) Patent Application Publication
(10) Pub. No.: US 2008/0240087 A1
(43) Pub. Date: Oct. 2, 2008

(54) HYBRID INTERNET PROTOCOL BASED SESSION CONTROL PROTOCOL AND PSTN COMMUNICATIONS

(75) Inventor: William David Goodman, Collegeville, PA (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Services Corp., Arlington, VA (US)

(21) Appl. No.: 11/610,298

(22) Filed: Dec. 13, 2006

(51) Int. Cl. H04L 12/66

(52) U.S. Cl. 370/354

(57) ABSTRACT

In one of many possible embodiments, a hybrid end-user communication apparatus includes a Public Switched Telephone Network (“PSTN”) interface enabling communication over a Public Switched Telephone Network (“PSTN”) and a packet-switched network interface enabling signaling over a packet-switched network. The apparatus is configured to use the signaling to control a communication over the PSTN. In certain embodiments, the signaling includes Session Initiation Protocol (“SIP”) signaling. In certain embodiments, the communication over the PSTN includes a Public Switched Telephone Network (“PSTN”) media stream transmission over a Public Switched Telephone Network (“PSTN”) media bearer path.

### BACKGROUND INFORMATION

For years, reliable voice communication services have been provided over circuit-switched networks such as the Public Switched Telephone Network (“PSTN”) More recently, packet-switched networks (e.g., the Internet) capable of carrying data and voice communications have been developed. Such networks allow Internet Protocol (“IP”) enabled devices to send and receive IP-based voice communications between one another over packet-switched networks such as the Internet.

Initially, voice communications over the Internet were performed independently of voice communications over the PSTN. Accordingly, a person transmitting a voice communication over the Internet, for example, could send the voice communication to an IP-enabled device connected to the Internet but not to a PSTN device connected to the PSTN. However, technologies were later developed for bridging voice communications from the Internet to the PSTN and vice versa. Accordingly, a person subscribing to a Voice over Internet Protocol (“VoIP”) service could use the VoIP service to establish communications with PSTN devices connected to the PSTN. In addition, PSTN carriers could bridge voice communications from the PSTN to the Internet and back to the PSTN to reduce the costs of transmitting the voice communications over long distances.

However, conventional end-user devices have remained limited to using independent communications for circuit-switched and packet-switched networks. For example, a traditional end-user device may be designed to send and receive communications over the PSTN and/or the Internet, but the communications over the two separate networks are independent of one another. Consequently, conventional end-user devices cannot leverage cooperation between circuit-switched and packet-switched networks such as the PSTN and the Internet.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical reference numbers designate identical or similar elements.

FIG. 1 illustrates an example of a hybrid communication system, according to an embodiment.

FIG. 2A illustrates an exemplary signal flow in relation to the system of FIG. 1, according to an embodiment.

FIG. 2B illustrates another exemplary signal flow in relation to the system of FIG. 1, according to an embodiment.

FIG. 3 is a block diagram of an exemplary hybrid end-user communication device, according to an embodiment.

FIG. 4 is a flowchart illustrating an exemplary process for establishing a hybrid voice communication, according to an embodiment.

### DETAILED DESCRIPTION OF PREFERRED EMBODIMENTS

### I. Introduction

Preferred exemplary systems, apparatuses, and methods for hybrid Internet Protocol based session control protocol (e.g., Session Initiation Protocol (“SIP”)) and Public Switched Telephone Network (“PSTN”) communications are described herein. In certain embodiments, a hybrid end-user communication device (e.g., a hybrid SIP/PSTN telephone) is configured to use Internet Protocol based session control protocol signaling (e.g., SIP signaling) to control PSTN signaling (e.g., a PSTN communication and/or action) in the PSTN. Accordingly, the hybrid end-user communication device may use Internet Protocol based session control protocol signaling in combination with a PSTN media bearer path to support a voice communication. For example, a hybrid end-user device connected to the PSTN and to a packet-switched network may use SIP signaling (or other Internet Protocol based session control protocol) over the packet-switched network to establish or tear down a PSTN media bearer path between the hybrid device and another device connected to the PSTN. The hybrid end-user device may continue to use SIP signaling over the packet-switched network while sending or receiving a media stream (e.g., a telephone call) over a PSTN media bearer path.

The combination of Internet Protocol based session control protocol signaling over a packet-switched network and a PSTN transport path for a hybrid voice communication can leverage cooperation between the PSTN and a packet-switched network. For example, the hybrid end-user device can establish and use PSTN media bearer paths over the PSTN, as well as receive and use advanced services provided by way of the packet-switched network. In other words, a single hybrid communication can utilize services provided by two different network domains. Accordingly, advanced services can be provided to PSTN end users, thereby extending the availability of the advanced services beyond the reach of packet-switched networks such as VoIP networks. In addition, the use of Internet Protocol based session control protocol signaling over a packet-switched network can conserve resources on the PSTN, while the use of a PSTN media bearer path for media transport provides the high quality and reliability of a circuit-switched network.

In the examples described herein, SIP-based control signaling is employed over a packet-switched network. However, this is illustrative only and not restrictive in any sense. In other embodiments, other suitable Internet Protocol based session control protocols may be used, including Hypertext Transfer Protocol (“HTTP”), Simple Object Access Protocol (“SOAP”), Session Initiation Protocol for Instant Messaging and Presence Leveraging Extensions (“SIMPLE”), and Extensible Messaging and Presence Protocol (“XMPP”), for example.

### II. Exemplary System

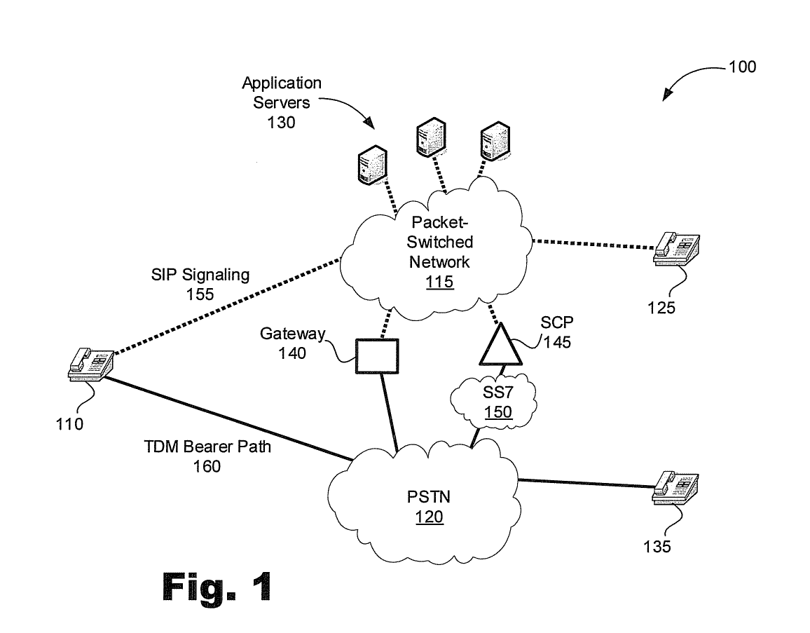

Turning now to the figures, FIG. 1 illustrates an example of a hybrid communication system 100, according to one embodiment. Hybrid communication system 100 (“system 100”) may take many different forms and include multiple and/or alternate components and facilities. While an exemplary system 100 is shown in FIG. 1, the exemplary components illustrated in the figure are not intended to be limiting. Indeed, additional or alternative components and/or implementations may be used, as is well known.

As shown in FIG. 1, system 100 may include a hybrid end-user communication device 110 (“hybrid device 110”) communicatively connected to a packet-switched network 115 and a Public Switched Telephone Network (“PSTN”) 120. An end-user device 125 and one or more application servers 130 may be communicatively connected to the packet-switched network 115, and an end-user device 135 may be communicatively connected to the PSTN 120. A gateway 140 and a service control point (“SCP”) 145 may be communicatively connected to both the packet-switched network 115 and the PSTN 120. The SCP 145 may use Signaling System 7 (“SS7”) protocols 150 to communicate with devices included in or connected to the PSTN 120.

Hybrid device 110 may be configured to send and receive communications over the packet-switched network 115 and the PSTN 120. The hybrid device 110 can be connected to the packet-switched network 115 and the PSTN 120 using any suitable communication technologies. In certain embodiments, for example, a single communication medium such as a telephone line may be used to connect the hybrid device 110 to both networks 115 and 120. Standard PSTN services may be provided over the telephone line such that the hybrid device 110 can communicate over the PSTN 120. In addition, packet-switched network services (e.g., Internet connectivity and/or VoIP services) may be provided over the telephone line. For example, Digital Subscriber Line (“DSL”) services may be provided over the telephone line such that the hybrid device 110 can communicate over the packet-switched network 115. Accordingly, the hybrid device 110 may be configured in certain embodiments to use a single connection to a single telephone line to concurrently communicate over the PSTN 120 and the packet-switched network 115.

However, other suitable connection configurations may be employed in alternative embodiments. For example, other embodiments of the hybrid device 110 may include separate PSTN and packet-switched network interface, including a telephone line interface for connecting to the PSTN 120 and an Ethernet interface for connecting to the packet-switched network 115.

The hybrid device 110 may be configured to participate in standard VoIP or PSTN communications over the packet-switched network 115 and/or the PSTN 120, as is well known. Gateway 140 may bridge communications between the packet-switched network 115 and the PSTN 120, as is also well known.

The hybrid device 110 may be configured to request, process, and terminate hybrid communications that leverage services and/or applications provided over the PSTN 120 and the packet-switched network 115. In certain embodiments, for example, the hybrid device 110 may be configured to initiate or receive a hybrid communication that employs control signaling over the packet-switched network 115 and a PSTN media bearer path over the PSTN 120 for transporting a media stream. For instance, the hybrid device 110 may use SIP signaling 155 (or other Internet Protocol based session control protocol signaling in other embodiments) over the packet-switched network 115 to request that elements of the PSTN 120 perform actions (e.g., establishing or tearing down) related to a PSTN media bearer path, which may also be referred to as a Time Division Multiplexing (“TDM”) bearer path 160. For example, the hybrid device 110 may request that the TDM bearer path 160 be established between the hybrid device 110 and another device connected to the PSTN 120. The TDM media bearer path 160 may include a PSTN circuit connecting the hybrid device 110 to the end-user device 135.

The hybrid device 110 may be configured to use SIP signaling 155 over the packet-switched network 115 before a PSTN bearer path is established, while a PSTN bearer path is established, while a media stream is being transported over a PSTN bearer path, or after a PSTN bearer path has been torn down. The SIP signaling 155 may include any control signaling related to a PSTN media bearer path over the PSTN 120.

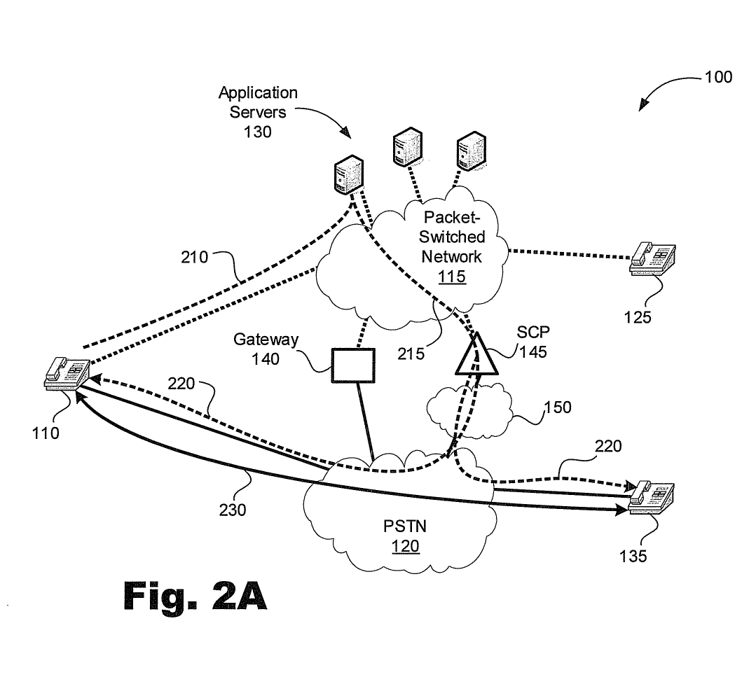

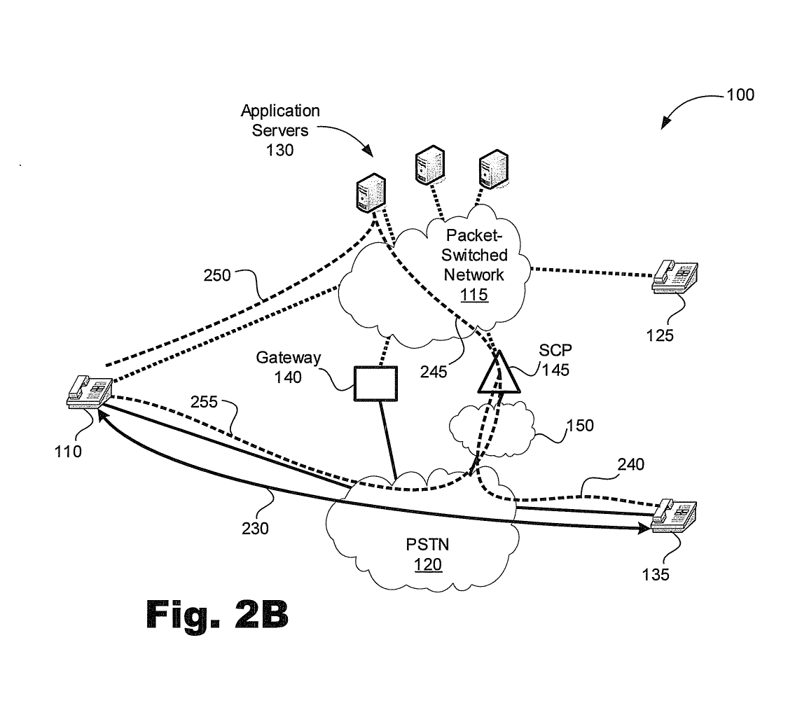

FIG. 2A illustrates an exemplary signal flow for establishing a hybrid communication, according to one embodiment. Hybrid device 110 may send a SIP request over the packet-switched network 115 to an application server 130 connected to the packet-switched network 115, as represented by reference number 210 in FIG. 2A. The hybrid device 110 may be configured to send the request in response to a predetermined event, such as a user instruction to call a target telephone number, for example.

The application server 130 receiving the request may include a SIP server and service logic configured to apply advanced services (e.g., advanced voice and/or signaling services) in response to the request. The application server 130 may employ any of the technologies and apply any of the advanced services described in co-pending U.S. patent application Ser. No. 10/850,915, entitled “Systems and Methods For Integrating PSTN And IP Application Platforms To Enable Advanced Telephony Services,” filed May 20, 2004 and hereby fully incorporated herein by reference in its entirety. Examples of advanced services that may be provided by the application servers 130 include, but are not limited to, call routing, call forwarding, “do not disturb,” call rejection, calendaring applications, video applications, messaging applications, and gaming applications.

Different combinations of the application servers 130 may be configured to cooperate to provide advanced services. For example, a voice application server may query a presence server before deciding how to react to a termination call attempt. If the user presence status indicates the presence of the user at a particular device, the voice application server may send the communication to the device. On the other hand, if the user presence status indicates that the user is not present at the device, the voice application server may take other action such as routing the communication to a different destination.

In response to the request, the application server 130 may communicate with the SCP 145 to initiate cooperation between packet-switched network services and PSTN services. The application server 130 and the SCP 145 may communicate over the packet-switched network 115 using any suitable communication technologies and processes, including any of those described in the above noted co-pending U.S. patent application Ser. No. 10/850,915. For example, the application server 130 may use predefined service logic to determine and provide call routing instructions to the SCP 145 over the packet-switched network 115.

The packet-switched network 115 may include one or more packet-switched networks, including, but not limited to, any Internet Protocol based (“IP-based”) networks (e.g., VoIP networks), local area networks, wide area networks, metropolitan area networks, wireless communication networks, public land mobile network (“PLMN”), Transmission Control Protocol/Internet Protocol (“TCP/IP”) networks, packet-switched mobile networks (e.g., a mobile IP network, general packet radio service (“GPRS”), or digital cellular telephone network), provider-specific IP-based networks, intranets, and the Internet.

Devices included in or connected to the packet-switched network 115 may be configured to send and receive data packets between one another using any suitable transmission media and protocol(s). In certain embodiments, SIP is used for communications between the devices included in or connected to the packet-switched network 115, including communications between the application server 130 and the SCP 145, as represented by reference number 215 in FIG. 2A. As mentioned above, other embodiments may employ other suitable Internet Protocol based session control protocols for communications over the packet-switched network 115.

The SCP 145 may be connected to and configured to send and receive communications over the packet-switched network 115 and the PSTN 120. Accordingly, the SCP 145 enables the networks 115 and 120 to cooperate in support of hybrid communications, including allowing advanced services (e.g., SIP signaling) of the packet-switched network 115 to be used to support or augment communications transported over the PSTN 120. The SCP 145 may employ any of the technologies and processes described in the above noted U.S. patent application Ser. No. 10/850,915 to enable inter-network communications.

Once instructions (e.g., routing instructions) have been received from the application server 130, the SCP 145 is able to communicate with elements included in or connected to the PSTN 120 in order to execute the instructions. Communications between the SCP 145 and elements of the PSTN 120 may be accomplished using any of the devices, technologies, and processes described in co-pending U.S. patent application Ser. No. 10/850,915. For example, the SCP 145 may communicate with signal transfer points (“STPs”), which may in turn communicate with service switching points (“SSPs”), including SSPs to which the hybrid device 110 and the end-user device 135 are connected.

In the example of the hybrid device 110 using SIP signaling to establish a PSTN call to end-user device 135, the SCP 145 may communicate with elements of the PSTN 120 to originate a call between the hybrid device 110 and the end-user device 135 (i.e., a third-party call origination). In particular, the SCP 145 can cause signals 220 to be sent to the endpoint devices. The signals 220 may be configured to provide dial tone to the hybrid device 110, and to send a ring signal to the end-user device 135. If the end-user device 135 responds by going off-hook or otherwise answering (e.g., by a user or messaging service answering), the elements of the PSTN 120 may establish a PSTN media bearer path 230 (e.g., a circuit) between the endpoint devices, as is well known. Communications (e.g., voice communications) may then be sent (e.g., as a media stream transmission) between the hybrid device 110 and the end-user device 135 via the PSTN media bearer path 230.

The signal flow for establishing a hybrid communication as shown in FIG. 2A is illustrative only and not in any sense restrictive. Other hybrid communications including a PSTN media bearer path over the PSTN 120 and SIP signaling over the packet-switched network 115 may be carried out in similar fashion. Accordingly, the hybrid device 110 is able to participate in hybrid communications that include a PSTN transport path and control signaling over a packet-switched network 115.

For example, while FIG. 2A illustrates an exemplary signal flow for a communication initiated by the hybrid device 110, FIG. 2B illustrates an exemplary signal flow for a communication initiated by end-user device 135 and received by the hybrid device 110. As shown in FIG. 2B, the end-user device 135 (e.g., a PSTN device) may send a request over the PSTN 120 to initiate a communication with the hybrid device 110. The request, which is denoted as reference number 240 in FIG. 2B, may be routed over the PSTN 120 via an Advanced Intelligent Network (“AIN”) to the packet-switched network 115 domain. In particular, the request may be routed to the SCP 145, which may use SIP signaling to communicate the request to an application server 130 over the packet-switched network 115, as represented by reference number 245 in FIG. 2B.

The application server 130 may then send a SIP message to signal the hybrid device 110, as denoted by reference number 250 in FIG. 2B. The SIP message may be an INVITE message, or any other message suitable for notifying the hybrid device 110 of the communication request initiated by the end-user device 135. For example, the message may include instructions configured to cause the hybrid device 110 to ring and/or other information such as caller identification information.

If the hybrid device 110 responds by going off-hook or otherwise answering (e.g., by a user or messaging service answering), the elements of the PSTN 120 and the packet-switched network 115 may establish a PSTN media bearer path 230 (e.g., a circuit) between the endpoint devices. For example, the hybrid device 110 may use information included in the received SIP signaling to identify and communicate with the SCP 145 over the PSTN 120, as denoted by reference number 255. The SCP 145 can receive the signal from the hybrid device 110 and communicate with other elements of the PSTN 120 to establish a PSTN media bearer path 230 (e.g., a circuit) between the endpoint devices, as is well known. Communications (e.g., voice communications) may then be sent (e.g., as a media stream transmission) between the hybrid device 110 and the end-user device 135 via the PSTN media bearer path 230. In this manner, the hybrid device 110 is able to use a combination of SIP signaling and a PSTN media bearer path 230 to terminate an incoming communication directed to the hybrid device 110.

While the examples shown in FIGS. 2A-B are directed to communications between the hybrid device 110 and an end-user device 135 connected to the PSTN 120, the hybrid device 110 may similarly use SIP signaling and a PSTN media bearer path for communications with an end-user device connected to the packet-switched network 115. For communications with end-user device 125, for example, end-to-end SIP signaling may be used between the hybrid device 110 and the end-user device 125, and a combination of a PSTN media bearer path and media carrying signals over the packet-switched network may be used between the endpoints. For example, SIP signaling may setup and/or teardown a PSTN media bearer path between the hybrid device 110 and gateway 140, and SIP signaling may be used to control media bearing communications between the gateway 140 and the end-user device 125. In this or similar manner, the hybrid device 110 may use end-to-end SIP signaling over the packet-switched network and a PSTN bearer path in combination with packet-switched network media carrying signals for hybrid communications with an end-user device connected to the packet-switched network 115.

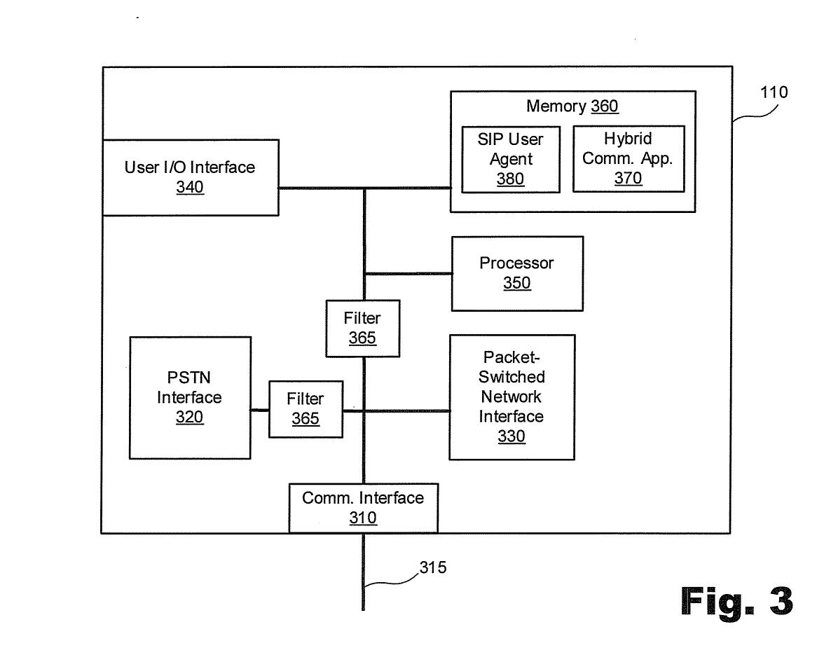

To facilitate an understanding of the hybrid device 110, FIG. 3 illustrates an exemplary hybrid device 110, according to an embodiment. In FIG. 3, the hybrid device 110 includes a hybrid SIP/PSTN telephone. In other embodiments, the hybrid device 110 may include or be implemented in other devices, including, but not limited to, a personal computer, gaming console, video phone, Verizon One® phone, and set-top box.

In certain embodiments, the hybrid device 110 may include any computer hardware and/or instructions (e.g., software programs), or combinations of software and hardware, configured to perform the processes described herein. In particular, it should be understood that hybrid device 110 may be implemented on one physical computing device or may be implemented on more than one physical computing device. Accordingly, hybrid device 110 may include any one of a number of well known computing devices, and may employ any of a number of well known computer operating systems, including, but by no means limited to, known versions and/or varieties of the Microsoft Windows® operating system, the Unix operating system, Macintosh® operating system, and the Linux operating system.

Accordingly, the processes described herein may be implemented at least in part as instructions executable by one or more computing devices. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

As shown in FIG. 3, the hybrid device 110 may include a communication interface 310 configured to connect the device 110 to a transmission medium such as a standard telephone line 315. Communication interface 310 may include any suitable components (e.g., a standard telephone jack) for physically and communicatively connecting the hybrid device 110 to the transmission medium. While FIG. 3 illustrates a connection to a telephone line, this is not limiting. Other suitable transmission media may be used to connect the hybrid device 110 to the PSTI 120 and the packet-switched network 115. In other embodiments, for example, the communication interface 310 may connect the hybrid device 110 to the PSTN 120 via the telephone line 315 and to the packet-switched network 115 via an Ethernet interface.

The exemplary hybrid device 110 of FIG. 3 further includes a PSTN interface 320, packet-switched network interface 330, user input/output interface 340, processor 350, and memory 360 communicatively connected to one another and to the communication interface 310 as shown. The PSTN interface 320 may include any components and technologies for communicating over the PSTN 120 via the communication interface 310. For example, the PSTN interface 320 may include a hook switch, which is well known. Accordingly, the hybrid device 110 may be configured for standard PSTN communications over the PSTN 120, including sending and receiving media over a PSTN media bearer path connecting the hybrid device 110 to another device connected to the PSTN 120.

The packet-switched network interface 330 may include any components and technologies for communicating over the packet-switched network 115 via the communication interface 310. For example, the packet-switched network interface 330 may include an IP transceiver (e.g., a modem), which is well known. Accordingly, the hybrid device 110 may be configured for standard packet-switched communications over the packet-switched network 115, including VoIP communications in some examples. For example, the hybrid device 110 may communicate with end-user device 125 entirely over the packet-switched network 115 and using end-to-end SIP signaling. The packet-switched network interface 330 may be configured to support the sending and receiving of control signals, including SIP signaling that is sent and/or received via the communication interface 310.

The user input/output interface 340 may include any components and technologies for providing output to and receiving input from a user of the hybrid device 110. For example, the user input/output interface 340 may include a microphone, amplifier, audio speaker, duplex coil, touchtone keypad, frequency generator, pulse generator, rotary dialer, ringer, and display, which are well known.

As shown in FIG. 3, the hybrid device 110 may also include one or more filters 365 (e.g., a DSL filter) or other technologies for isolating certain elements of the device 110 from PSTN or packet-switched network communication signals.

The processor 350 may be configured to control some or all operations of the hybrid device 110. With respect to hybrid communications, for example, the processor 350 may control which portions of a hybrid communication are carried over the PSTN 120 or the packet-switched network 115.

The processor 350 may execute instructions implemented as application clients stored in memory 360. Memory 360 may include any suitable data storage media and technologies.

The application clients may include a hybrid communication application 370 and SIP user agent 380, as shown in FIG. 3. The SIP user agent 380 may include instructions for generating, sending, receiving, and interpreting SIP messages, including well-known request and response messages (e.g., INVITE, ACK, and BYE). The SIP user agent 380 may be executed on the hybrid device 110 to enable SIP signaling over the packet-switched network 115. The SIP signals may include control signals for a hybrid communication, including but not limited to some or all control signals associated with a voice call over the PSTN 120. Examples of such control signals include, but are not limited to, a call origination signal (e.g., an “off-hook” signal), a target telephone number (e.g., a number dialed by a user), a “cannot complete a call” signal, a ringer signal, and a call termination signal (e.g., an “on-hook” signal).

The hybrid communication application 370 may be executed on the hybrid device 110 to control hybrid communications to which the hybrid device 110 is a participator. With respect to establishing a PSTN bearer path for a voice call on the PSTN 120, for example, a user of the hybrid device 110 may use the user input/output interface to dial a target telephone number. The dialing of a target telephone number (or other user input) may be predefined as an event that will be detected by the processor 350, Accordingly, processor 350 may detect the dialing of the target telephone number and, in accordance with instructions included in the hybrid communication application 370 and the SIP user agent 380, may generate a SIP request. The processor 350 may then direct the packet-switched network interface 330 to send the SIP request to an application server 130 by way of the communication interface 310 and the packet-switched network 115.

The application server 130, SCP 145, and elements of the PSTN 120 may function as described above to originate a PSTN media bearer path between the hybrid device 110 and a device associated with the target telephone number. The PSTN interface 320 of the hybrid device 110 may receive PSTN signals via the communication interface 310, including a dial tone signal, ring signal, busy signal, established connection signal (e.g., termination of a ring signal), or media transmission signal transported to the hybrid device 110 over a PSTN media bearer path. Accordingly, the hybrid device 110 may be connected to a PSTN device by a PSTN media bearer path, where at least some control signals associated with the PSTN bearer path are carried over the packet-switched network 115.

The use of SIP signals for control signaling over packet-switched network 115 can generally conserve resources on the PSTN 120. For example, PSTN circuits do not have to be dedicated just for control signaling between different devices connected to the PSTN. Rather, a relatively small amount of best-effort or Quality of Service (“QoS”) packet network bandwidth can be used to accommodate SIP signaling while the benefits (e.g., reliability and high signal quality) of a PSTN transport network can still be used for media stream transmissions.

In addition, the combination of SIP signaling and a PSTN media bearer path for a voice communication can leverage cooperation between the PSTN 120 and packet-switched network 115. Accordingly, hybrid communication devices connected to the PSTN 120 and the packet-switched network 115 can receive and use services from both the PSTN 120 and the packet-switched network 115, including advanced services provided by way of the packet-switched network 115. This generally extends the availability of the advanced services beyond VoIP networks to PSTN subscribers.

PSTN operators or service providers may also benefit by being able to leverage advanced services provided on packet-switched networks. Accordingly, PSTN service providers can offer advanced services to PSTN subscribers prior to the availability of a ubiquitous QoS VoIP infrastructure. In addition, the advanced services may be used by PSTN operators to control clients on the PSTN 120.

### III. Exemplary Process View

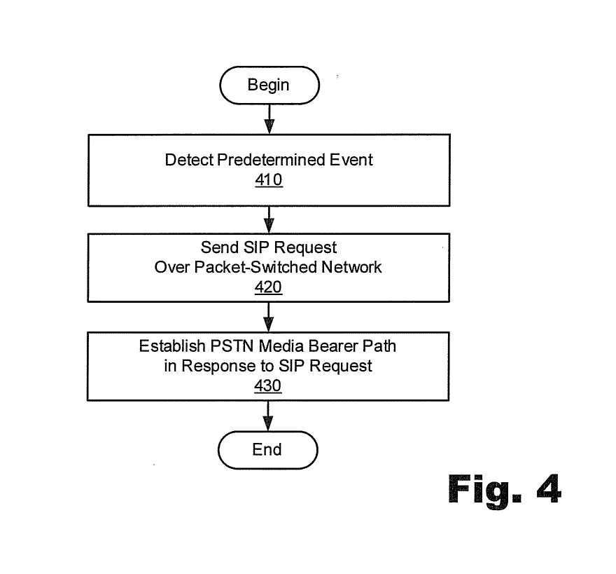

FIG. 4 illustrates an exemplary method of establishing a hybrid voice communication, according to an embodiment. While FIG. 4 illustrates exemplary steps according to one embodiment, other embodiments may omit, add to, and/or modify any of the steps shown in FIG. 4.

In step 410, a predetermined event is detected by a hybrid communication device. The predetermined event may include a user action detected by the hybrid device 110. The predetermined event may include, but is not limited to, an “off-hook,” telephone number dialing, or “on-hook” event.

In step 420, the hybrid communication device sends a SIP request over a packet-switched network. Step 420 may be performed in any of the ways described above, including, for example, hybrid device 110 sending SIP request 210 to an application server 130 over the packet-switched network 115.

In step 430, a PSTN media bearer path is established in response to the SIP request. Step 430 may be performed in any of the ways described above, including, for example, the application server 130 communicating routing instructions to the SCP 145, which then communicates with elements of the PSTN 120 to establish PSTN media bearer path 230 between the hybrid device 110 and another device connected to the PSTN 120.

While the method illustrated in FIG. 4 is directed to establishing a hybrid communication, this is not limiting. The steps of FIG. 4 may be modified for other hybrid communication actions. For example, step 430 may be modified to include tearing down a PSTN media bearer path when the predetermined event of step 410 includes a call termination signal such as an “on-hook” event.

The steps of FIG. 4 may also be modified for an incoming communication. For example, the predetermined event of step 410 may include receipt of a SIP request notifying the hybrid device 110 of an incoming communication request. In this situation, step 420 may include the hybrid device 110 sending a signal over the PSTN 120 (e.g., an AIN signal sent to the SCP 145). Alternatively, step 420 may include the hybrid device 110, in response to an off-hook event, generating a SIP signaling response back to the application server 130. In step 430, a PSTN media bearer path may be established between the endpoint devices, as described above. In this manner, the hybrid device 110 can terminate an incoming communication.

### IV. Alternative Embodiments

The preceding description has been presented only to illustrate and describe exemplary embodiments with reference to the accompanying drawings. It will, however, be evident that various modifications and changes may be made thereto, and additional embodiments may be implemented, without departing from the scope of the invention as set forth in the claims that follow. The above description and accompanying drawings are accordingly to be regarded in an illustrative rather than a restrictive sense.

What is claimed is:

1. A hybrid end-user communication apparatus comprising:
a Public Switched Telephone Network (“PSTN”) interface enabling communication over a Public Switched Telephone Network (“PSTN”); and
a packet-switched network interface enabling signaling over a packet-switched network;
wherein said apparatus is configured to use said signaling to control a communication over the PSTN.

2. The apparatus of claim 1, wherein said signaling includes Internet Protocol based session control protocol signaling.

3. The apparatus of claim 2, wherein said signaling includes at least one of Session Initiation Protocol (“SIP”), Hypertext Transfer Protocol (“HTTP”), Simple Object Access Protocol (“SOAP”), Session Initiation Protocol for Instant Messaging and Presence Leveraging Extensions (“SIMPLE”), and Extensible Messaging and Presence Protocol (“XMPP”) signaling.

4. The apparatus of claim 1, wherein said communication over the PSTN includes a Public Switched Telephone Network (“PSTN”) media stream transmission over a Public Switched Telephone Network (“PSTN”) media bearer path.

5. The apparatus of claim 1, wherein said communication includes establishing a Public Switched Telephone Network (“PSTN”) media bearer path over the PSTN, said signaling being configured to direct said establishment of said PSTN media bearer path.

6. The apparatus of claim 1, wherein said communication includes tearing down a Public Switched Telephone Network (“PSTN”) media bearer path over the PSTN, said signaling being configured to direct said tearing down of said PSTN media bearer path.

7. The apparatus of claim 1, wherein said communication over the PSTN includes signals representative of a voice communication.

8. The apparatus of claim 1, further comprising:
a processor communicatively connected to said PSTN interface and said packet-switched network interface; and
a memory communicatively connected to said processor, said memory storing a Session Initiation Protocol (“SIP”) user agent;
wherein said SIP user agent is configured to instruct said processor to use Session Initiation Protocol (“SIP”) signaling to control said communication over the PSTN.

9. The apparatus of claim 1, further comprising a communication interface communicatively connected to said PSTN interface and said packet-switched network interface, said communication interface providing a connection to the packet-switched network and the PSTN via a single telephone line.

10. The apparatus of claim 1, further comprising a communication interface communicatively connected to said PSTN interface and said packet-switched network interface, said communication interface providing a connection to the PSTN via a telephone line and to the packet-switched network via an Ethernet interface.

11. The apparatus of claim 1, wherein the packet-switched network includes at least one of the Internet and a provider-specific Internet Protocol based network.

12. An apparatus comprising:
a Public Switched Telephone Network (“PSTN”) interface enabling communication over a Public Switched Telephone Network (“PSTN”);
a packet-switched network interface enabling communications over a packet-switched network;
a processor communicatively connected to said PSTN interface and said packet-switched network interface; and
a memory communicatively connected to said processor, said memory storing a Session Initiation Protocol (“SIP”) user agent;
wherein said SIP user agent is configured to instruct said processor to use Session Initiation Protocol (“SIP”) signaling to control a communication action in the PSTN.

13. The apparatus of claim 12, wherein said communication action includes at least one of establishing and tearing down a Public Switched Telephone Network (“PSTN”) media bearer path connecting said apparatus to a device connected to the PSTN.

14. The apparatus of claim 12, further comprising a user interface communicatively connected to said processor, said processor configured to detect a predetermined event initiated by a user through said user interface and to initiate said SIP signaling over the packet-switched network in response to said predetermined event being detected.

15. The apparatus of claim 14, wherein said predetermined event includes a user dialing a target telephone number, said SIP signaling including a request to establish a Public Switched Telephone Network (“PSTN”) media bearer path between said apparatus and a device associated with the target telephone number.

16. The apparatus of claim 15, wherein said PSTN interface is configured to transmit and receive a Public Switched Telephone Network (“PSTN”) media stream over said PSTN media bearer path.

17. The apparatus of claim 16, wherein said PSTN media stream includes signaling representative of a voice communication.

18. The apparatus of claim 12, wherein said packet-switched network interface is configured to receive a SIP signaling request over the packet-switched network, said SIP signaling request being associated with an incoming communication request to establish a Public Switched Telephone Network (“PSTN”) media bearer path between said apparatus and a device originating the incoming communication request over the PSTN.

19. A method comprising:
an end-user communication device employing Internet Protocol based session control protocol signaling over a packet-switched network controlling a Public Switched Telephone Network (“PSTN”) media bearer path of a Public Switched Telephone Network (“PSTN”); and
said end-user communication device transmitting or receiving Public Switched Telephone Network (“PSTN”) signaling over said PSTN media bearer path.

20. The method of claim 19, wherein said employing of Internet Protocol based session control protocol signaling includes providing an Internet Protocol based request over the packet-switched network, and configuring said Internet Protocol based request for establishing said PSTN media bearer path between said end-user communication device and another device connected to the PSTN.

21. The method of claim 20, further comprising:
detecting a predetermined event initiated by a user; and
performing said providing of said Internet Protocol based request over the packet-switched network in response to said detection.

22. The method of claim 19, wherein said employing of Internet Protocol based session control protocol signaling includes receiving an Internet Protocol based request over the packet-switched network, said Internet Protocol based request being associated with an incoming communication request to establish said Public Switched Telephone Network (“PSTN”) media bearer path, the incoming communication request originating on the PSTN.

23. The method of claim 19, wherein said employing of Internet Protocol based signaling includes providing an Internet Protocol based request over the packet-switched network, and configuring said Internet Protocol based request for tearing down said PSTN media bearer path between said end-user communication device and another device connected to the PSTN.

24. The method of claim 19, further comprising said end-user communication device receiving an advanced service associated with the packet-switched network.
